(19) United States
(12) Patent Application Publication
(10) Pub. No.: US 2021/0047702 A1
(43) Pub. Date: Feb. 18, 2021

(54) METHOD TO CONTROL SLAG FOAMING IN A SMELTING PROCESS

(71) Applicant: TATA STEEL NEDERLAND TECHNOLOGY B.V., Velsen-Noord (NL)

(72) Inventors: Ömer ARSLAN, AMSTERDAM (NL); Reinier BARLO, HEERHUGOWAARD (NL)

(73) Assignee: TATA STEEL NEDERLAND TECHNOLOGY B.V., Velsen-Noord (NL)

(21) Appl. No.: 16/969,301

(22) PCT Filed: Jan. 15, 2019
(86) PCT No.: PCT/EP2019/050864

§ 371 Date: Aug. 12, 2020

(30) Foreign Application Priority Data
Feb. 15, 2018 (EP) 18156983.1

(51) Int. Cl. C21C 5/35; C21C 5/46; C21C 5/36

(52) U.S. Cl. CPC C21C 5/35; C21C 5/4673; C21C 2300/06; C21C 2005/366; C21C 2300/02; C21C 5/36

(57) ABSTRACT

A method to control slag foaming in a smelting process in a vessel for smelting an iron-containing feed material including the steps of:
measuring vibration of the metallurgical vessel with an accelerometer at one or more positions on the vessel,
comparing values derived from accelerometer data with a threshold value which indicates the onset of a slag foaming incident, and
adjusting the smelting process if the value derived from the accelerometer data passes a predefined alarm value,
wherein the smelting process is adjusted by adjusting the amounts of the gaseous and/or the solid components injected in the smelting process.

### FIELD OF THE INVENTION

The invention relates to a method to predict and control slag foam incidents in a smelting process in a metallurgical vessel.

### BACKGROUND OF THE INVENTION

Slag foaming is a well-known aspect in steelmaking in electric arc furnaces and basic oxygen furnaces. In an oxygen converter unstable slag foaming is known to result in slopping, which is the blow-up of the material contained in the converter.

Slag foaming is also known to occur in smelting reduction vessels for instance in the HIsarna smelting reduction vessel.

The HIsarna process is carried out in a smelting apparatus that includes (a) a smelting vessel provided with solids injection lances and oxygen-containing gas injection lances and is adapted to contain a bath of molten metal and (b) a smelt cyclone for partly reducing and smelting a metalliferous feed material which is positioned above and is in communication with the smelting vessel. The HIsarna process and the apparatus for the process are described in WO 00/022176.

In the HIsarna pilot plant a number of foaming events have occurred in the campaigns so far. Two types of foaming event were observed, a first type of slag foaming with a sudden and major evolution of foam with no advanced warning from the plant signals and a second type of slag foaming with a slower build up to foaming conditions. The first type of slag foaming, the sudden evolution of foam, was most likely triggered by the fall of large oxide accretions from the off-gas duct into the smelting reduction vessel which brought a large and uncontrolled oxygen input into the slag-metal system leading to a rapid increase in gas evolution. The second type of slag foaming, the slower type, appears to be related to a low process temperature with a partially solid slag and a high effective viscosity leading to high gas hold-up in the slag.

The second type of slag foaming event is a gradual event in which slag on top of the hot metal bath builds up, aided by bad slag composition and/or excessive gas formation, to a point that it starts to capture more and more gas and grows rapidly in volume. Once it passes a certain volume threshold in the smelting reduction vessel, being the level of the oxygen injection lances, the oxygen from these lances will suddenly pump up the volume, similar to blowing bubbles in soap water, and slag can reach or even pass the pressure relieve valve of the smelting reduction vessel. When the slag passes the pressure relieve valve the damage by the solidifying slag and hot metal not only concerns the smelting reduction vessel but also the outside and direct vicinity of the vessel.

The aim is to provide a solution to predict and prevent slag foaming events of the second type.

### Objectives of the Invention

It is an objective of the present invention to provide a method to predict slag foaming events.

It is another objective of the present invention to provide a method to prevent slag foaming events.

It is another objective of the present invention to provide a method to predict and prevent slag foaming events that can be applied in a cost effective manner.

It is another objective of the present invention to provide a method to predict and prevent slag foaming events that can be applied in a simple manner.

### DESCRIPTION OF THE INVENTION

The invention relates to a method as defined in claims 1-17. One or more of the objectives of the invention are realised by providing a method to control slag foaming in a smelting process in a vessel for smelting an iron-containing feed material comprising the steps of:
measuring vibration of the metallurgical vessel with an accelerometer at one or more positions on the vessel,
comparing values derived from accelerometer data with a threshold value which indicates the onset of a slag foaming incident, and
adjusting the smelting process if the value derived from the accelerometer data passed a predefined alarm value or comes within a predefined alarm range,
wherein the smelting process is adjusted by adjusting the amounts of the gaseous and/or the solid components injected in the smelting process.

It was found in practice that it is possible to predict slag foaming events beforehand by using accelerometer data collected real time and control the input rates to the vessel and cyclone with sufficient time left to stabilize the process. The threshold value is determined on basis of historical accelerometer data, wherein the values derived from the historical accelerometer data comprise values which indicate the onset of a slag foaming event. By comparing the values derived from real time accelerometer data with the threshold value, it can be established whether or not a slag foaming event is about to occur.

The threshold value is a value representing a stage before a foaming event wherein the actual foaming event is not yet taking place and which is sufficiently in advance of the predicted foaming event to occur to be able to prevent the foaming event by adjusting the process. It was found that with the method a possible foaming event could be predicted in about 20 minutes in advance giving ample time to control the smelting process and therewith to prevent that the foaming event could occur.

A number of measures can be taken if it is established that a foaming event is going to occur without adjusting the process.

A typical adjusting step is adjusting the amount of oxygen injected in the smelting process. If the slag foam reaches the oxygen injectors in the smelting reduction vessel, oxygen injection will result in an increase in slag foaming and in most if not all circumstances will make the foaming event no longer controllable. The adjustment means decreasing the amount of injected oxygen and could include the total oxygen shut off, certainly if the foam is already rising in the vessel. A foaming event will also result in a pressure increase in the vessel, but at the time that the pressure has increased sufficiently to be able to measure the pressure increase the foaming event is already taking place and it will no longer be possible to control the foaming event.

Another adjusting step is adjusting the amount of coal injected in the smelting process. The gasification of coal contributes to slag foaming and should be controlled carefully and adjusted when a foaming event is predicted on basis of the values derived from the vibration measurement data. Adjusting of the amount of coal injected in the process means decreasing the amount of injected coal and could include that the coal injection is shut off completely.

Another adjusting step is adjusting the amount of iron-containing feed material injected in the smelting process. Adjusting means decreasing the amount of injected iron-containing feed material and could include that the iron-containing feed material injection is shut off completely. The reduction of iron ore has a direct effect on the amount of slag accumulating in the vessel and the associated gas formation. Reducing slag build up will reduce the likeliness of.

Another adjusting step is adjusting the amount of lime injected in the smelting process. The lime injected is one of the factors that determine the basicity and viscosity of the slag and therewith the extent of the slag foaming. Adjusting means decreasing the amount of injected lime material and could include that the lime material injection is shut off completely.

Typically it is provided that the basicity of the slag is monitored and the amount of lime injected in the smelting process is adjusted to keep the basicity of the slag in a predefined range or restore the basicity of the slag to within the predefined range.

Adjusting the amounts of gaseous and solid components is reducing the amounts of gaseous and solid components when the value derived from the accelerometer data corresponds to the threshold value. The term “corresponds” means that the value is equal to the threshold value or has passed the threshold value or is within a predefined range around the threshold value. Reducing includes decreasing as well as shutting off. Adjusting of the amounts of gaseous and solid components can be done successively or two or more components can be adjusted at the same time.

According to a further aspect it is provided that the method further comprises draining slag from the vessel. With this measure the amount of slag present in the smelting vessel is reduced and is only started when it is safe to start slag tapping. Opening the slag tap hole typically means drilling an open connection with the outside. When a slag foaming event is already progressing the slag might be forced out of the open connection. Therefore slag tapping will only be started either when the build-up is detected early on or after the process and therewith the forming of slag is back in control. Moreover, starting when the foaming event is already progressing will be too late because of the speed with which the foaming event will fill the smelting vessel.

According to a still further aspect when adjusting the amount of injected oxygen, the amount of oxygen injected in the smelting process is adjusted to a predefined excess of CO gas. The reason for this is that only a limited amount of CO is allowed in the off gas in order to prevent that an explosive mixture in the off gas is formed. Therefore adjusting the amount of injected oxygen is only possible up to a certain CO level in the off gas. The limit of the CO level is as stipulated in the safety regulations.

Typically the adjustment of the gaseous and solid components injected in the process is started with the adjustment of the amount of oxygen injected in the smelting process followed by the adjustment of solid components in the following order: coal, iron-containing feed material and lime. Although typically adjustment is started with the adjustment of the components that contribute significantly to a possible foaming event, it is of course also possible to start with the adjustment of all components simultaneously. However, the idea is to start with adjustment as soon as a possible foaming event is detected and to control the process with adjustments as minor as possible to be able to continue the process after preventing a foaming event without too much disturbance of the smelting reduction process.

The method further comprise that the adjustment of the amounts of the gaseous and the solid components injected in the smelting process when the value derived from the accelerometer data comes at the right side of the threshold value is increasing the amounts of the gaseous and the solid components injected in the smelting process.

According to a further aspect it is provided that the vibration of the metallurgical vessel is measured with one or more accelerometers for predefined periods of time at predefined time intervals. With the accelerometers the vibration of the installation or of the smelting reduction vessel can be measured at different positions and in different directions. By using multiple accelerometers it can be determined easily at which location and in which direction the most relevant and/or reliable information can be obtained. Measuring the vibration in a horizontal direction provided very useful measurements.

Accelerometers provide data over a wide frequency range but in case of large installations such as a smelting reduction installation the frequency range in which the relevant vibrations will occur will be far narrower than the total frequency range over which an accelerometer is capable of measuring vibrations. For that reason it is provided that a relevant frequency range is determined wherein the vibrations of the smelting reduction installation occur and only the accelerometer data in that relevant frequency range is going to be processed. This will reduce the required data storage and computer power to process the accelerometer data.

The method provided to process the accelerometer data comprises the steps of:
converting the obtained accelerometer data set from the time domain into the frequency domain,
integrating the data set in the frequency domain to a frequency/velocity data set,
determining the peak velocity value and the variation of the peak velocity value over time,
comparing the determined peak velocity value with a determined threshold value which correlates with a slag foaming event, and
adjusting the amounts of the gaseous and/or the solid components injected in the smelting process when the determined peak velocity value corresponds to the threshold value.

The meaning of the expression of “corresponds to the threshold value” is to be interpreted as including that the peak value nears, equals or passes the threshold value. Another possibility is to define a range for the threshold value and to take action whenever the peak value is within the defined threshold range.

### BRIEF DESCRIPTION OF THE DRAWINGS

The invention will be further explained on hand of the example shown in the drawing, in which:

FIG. 1 shows schematically a cross-section through an installation with a smelting reduction vessel and a smelt cyclone;

FIG. 2 shows converted accelerometer data of the installation under normal operation conditions, and

FIG. 3 shows converted accelerometer data of the installation at the time of a slag foaming event.

### DETAILED DESCRIPTION OF THE DRAWINGS

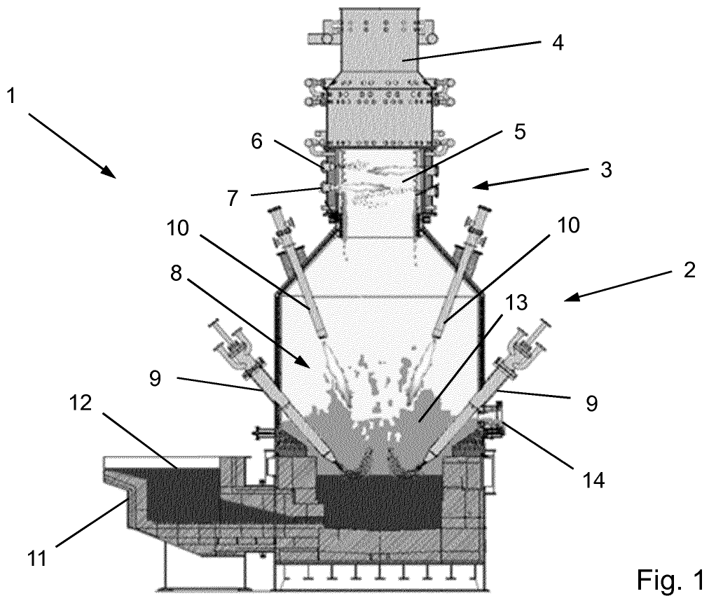

In FIG. 1 a smelting reduction installation 1 is shown with a smelting reduction vessel 2, a smelt cyclone 3 and an off-gas duct connecting part 4. The smelting cyclone comprises a vertical cylindrical chamber 5 provided with tuyeres 6 for injecting solid metalliferous feed materials and tuyeres 7 for injecting oxygen-containing gas into the chamber. The metalliferous feed materials are partly reduced and smelted before these arrive in the smelting reduction vessel 2. The smelting reduction vessel 2 defines a smelting chamber 8 and includes lances 9 for injecting solid feed materials and lances 10 for injecting oxygen-containing gas into the smelting chamber 8 and is adapted to contain a bath of molten metal and slag.

The smelting reduction vessel 2 includes a forehearth 11 connected to the smelting chamber 8 via a connection that allows continuous metal product 12 outflow from the vessel. The forehearth 11 operates as a molten metal-filled siphon seal, which allows the molten metal level in the smelting chamber 8 to be known and controlled to within a small tolerance. Molten slag 13 produced in the process is discharged from the smelting chamber 8 through a slag tap hole 14.

The level of the slag 13 under stable operation conditions is about as indicated in the figure. The slag 13 will splash around at about this level and is stable in height and in heat transfer to the copper cooled panels provided in the wall of the smelting reduction vessel.

With a slag foaming event the slag level will raise considerable and when the level of the oxygen lances 10 is reached the slag will become even more gaseous and will raise further in an accelerated manner. The foaming slag will reach the smelt cyclone 3 and beyond and at the same time could push the molten metal out of the smelting chamber 8 and out of the forehearth 11. With that the maximum possible damage is done and a time consuming and costly clean-up of the installation will be necessary.

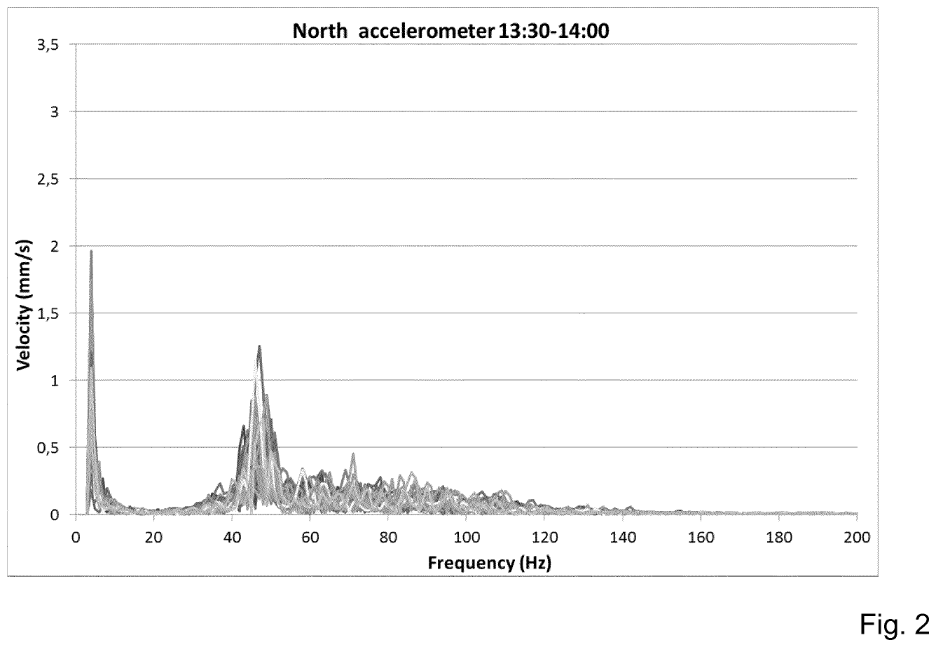

FIG. 2 shows converted accelerometer data of the installation under stable operation conditions. Accelerometers are placed on the outside of the installation, typically on the smelting reduction vessel 2 such that acceleration in various directions can be measured. An accelerometer is configured to measure accelerations for a period of time, after which the accumulated data is converted into the frequency domain using the Fast Fourier Transform. Since the installation or the smelting reduction vessel is vibrating at relatively low frequencies and with low speeds the converted data are integrated to view the vibrations in velocity rather than as acceleration.

With the present installation useful results were obtained by measuring the acceleration every minute for a period of 0.5 seconds over a frequency range of 1-4000 Hz and converting the data to a spectrum of velocity (mm/s) and frequency. By looking at a single spectrum there is in most cases not a clear pattern visible, but by plotting a number of successively measured spectra in the same graph a clear pattern becomes visible showing a peak velocity value around 45 Hz.

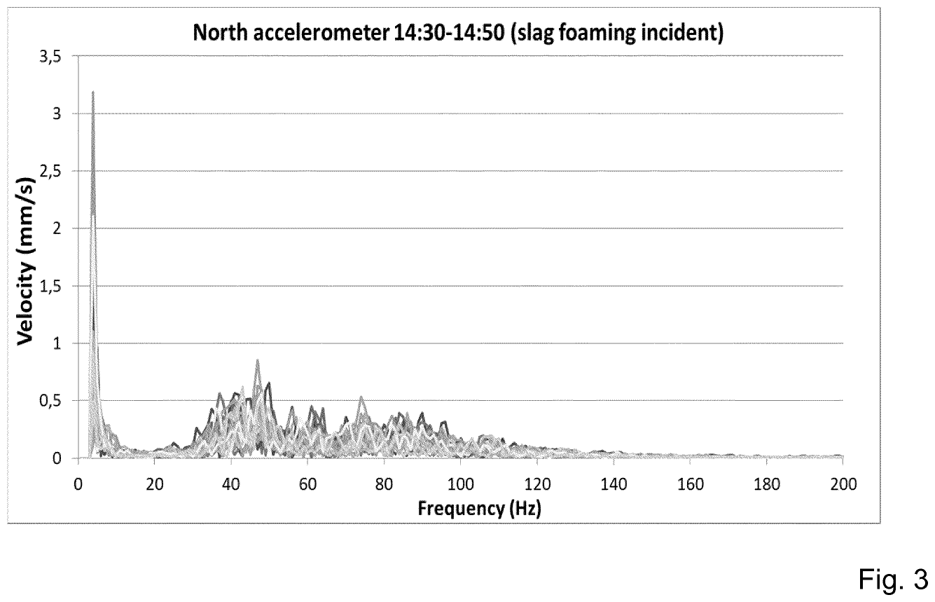

FIG. 3 shows converted accelerometer data of the installation at the time of a slag foaming event. It can be seen that the peak values around 45 Hz have decreased significantly which as it turned out can be used as a good indication of an impending foaming event.

At the lower frequency a large peak is shown which has to with the limitation of accelerometers at lower frequencies which is about 5 Hz and lower. For that reason all data below 5 Hz should not be used. It can further be seen that values above about 140 Hz do not show significant changes over time and for that reason should also not to be taken into account.

Good results have been obtained by only using data in a frequency range which is relevant for the method, which in this case is the range of 5-100 Hz. In order to damp the effect of sudden large deviations in peak velocity values a moving average of peak velocity values is determined and compared with the threshold value. A further correction is to apply an exponential smoothing to damp the peaks.

As an example: for the method an algorithm for a prediction model was build which comprises the following:

1. the installation should be in production mode for at least 15 minutes.
2. sample accelerometer data every minute in measurement periods of 0.5 seconds,
3. take the sum of all peaks between 5-100 Hz within one measurement period.
4. take the maximum peak in the 5-100 Hz range and divide the maximum peak by the sum of all peaks. This gives the contribution of the maximum peak with respect to the others.
5. Apply exponential smoothing with α=0,2 to damp the peaks
6. Take the 5 minute moving average of the calculated contribution factor to smooth the curve.
7. If there are 3 contribution factors within subsequent 5 minutes below 0.045 (threshold value), give an alarm.
Testing the prediction model based on the above algorithm on the historical data gave an alarm 20 minutes in advance before a slag foaming event and no alarms during stable production.

Instead of the above measurement periods of 0.5 sec every minute other measurements periods at different time intervals could be used which will also provide good results. For instance, with the given setup of the smelting reduction installation good results can be obtained if accelerometer data is sampled in successive sets of 0.1-2 seconds at an interval of 0.2-2 minutes.

1. A method to control slag foaming in a smelting process in a vessel for smelting an iron-containing feed material comprising the steps of:
measuring vibration of the metallurgical vessel with an accelerometer at one or more positions on the vessel to obtain accelerometer data,
comparing values derived from the accelerometer data with a threshold value which indicates the onset of a slag foaming incident, and
adjusting the smelting process if the value derived from the accelerometer data passes a predefined alarm value,
wherein the smelting process is adjusted by adjusting the amounts of the gaseous and/or the solid components injected in the smelting process.

2. The method according to claim 1, wherein said adjusting the smelting process comprises adjusting the amount of oxygen injected in the smelting process.

3. The method according to claim 1, wherein said adjusting step comprises adjusting the amount of coal injected in the smelting process.

4. The method according to claim 1, wherein said adjusting step comprises adjusting the amount of iron-containing feed material injected in the smelting process.

5. The method according to claim 1, wherein said adjusting step comprises adjusting the amount of lime injected in the smelting process.

6. The method according to claim 1, wherein the basicity of the slag is monitored and the amount of lime injected in the smelting process is adjusted to keep the basicity of the slag in a predefined range or restore the basicity of the slag to within the predefined range.

7. The method according to claim 2, wherein the adjusting step comprises adjusting the amounts of gaseous and solid components by reducing the amounts of gaseous and solid components when the value derived from the accelerometer data is in the alarm range.

8. The method according to claim 7, wherein the method further comprises draining slag from the vessel.

9. The method according to claim 1, wherein the amount of oxygen injected in the smelting process is adjusted to a predefined excess of CO gas.

10. The method according to claim 1, wherein the adjusting step comprises the adjustment of the gaseous and solid components injected in the smelting process which is started with the adjustment of the amount of oxygen injected in the smelting process followed by the adjustment of solid components in the following order: coal, iron-containing feed material and lime.

11. The method according to claim 1, wherein the adjusting step comprises the adjustment of the amounts of the gaseous and the solid components injected in the smelting process when the value derived from the accelerometer data comes at the right side of the threshold value by increasing the amounts of the gaseous and the solid components injected in the smelting process.

12. The method according to claim 1, wherein the vibration of the metallurgical vessel is measured with the one or more accelerometers for predefined periods of time at predefined time intervals.

13. The method according to claim 12, wherein a relevant frequency range is determined from which the accelerometer data is going to be processed.

14. The method according to claim 12, wherein the method comprises the steps of:
converting the obtained accelerometer data set from a time domain into a frequency domain,
integrating the data set in the frequency domain to a frequency/velocity data set,
determining the peak velocity value and the variation of the peak velocity value over time,
comparing the determined peak velocity value with a determined threshold value which correlates with a slag foaming event, and
said adjusting the amounts of the gaseous and/or the solid components injected in the smelting process when the determined maximum velocity value corresponds to the threshold value.

15. The method according to claim 14, wherein a moving average of peak velocity values is determined and compared with the threshold value.

16. The method according to claim 14, wherein a relevant frequency range is determined from which the accelerometer data is going to be processed.
